(19) United States
(12) Patent Application Publication
(10) Pub. No.: US 2025/0345731 A1
(43) Pub. Date: Nov. 13, 2025

(54) DIESEL FUEL FILTER

(71) Applicants: HYUNDAI MOTOR COMPANY, Seoul (KR); KIA CORPORATION, Seoul (KR)

(72) Inventors: Vamsee Krishna Aluri, Telangana (IN); Venkatesh Goud Madasu, Telangana (IN)

(73) Assignees: HYUNDAI MOTOR COMPANY, Seoul (KR); KIA CORPORATION, Seoul (KR)

(21) Appl. No.: 18/766,800

(22) Filed: Jul. 9, 2024

(30) Foreign Application Priority Data
May 10, 2024 (IN) 202411037113

(51) Int. Cl. B01D 36/00; B01D 17/02; F02M 37/28; F02M 37/32

(52) U.S. Cl. CPC B01D 36/005; B01D 17/02; B01D 36/006; F02M 37/28; F02M 37/32; B01D 2201/347; B01D 2201/4076

(57) ABSTRACT

A diesel fuel filter for a vehicle may include: a filter module filtering and storing water contained in diesel fuel; and a sensor module that is configured to sense the amount of the water stored in the filter module and discharge the water to the outside. The sensor module may include: a sensor housing having a drain hole; and a sensor body including a sensor tip to measure the amount of the water stored in the filter module. The sensor body includes a flap provided below the sensor tip, a sensor cover provided below the flap, and a sensor shaft provided inside the sensor cover to selectively communicate with the flap. The sensor module further includes: an elastic member providing elastic force to close the drain hole by the flap; and a driver selectively providing power to open the drain hole.

### CROSS REFERENCE TO RELATED APPLICATION

This application claims priority to and benefit of an Indian patent application No. 202411037113, filed on May 10, 2024, the entire contents of which are incorporated herein for all purposes by this reference.

### FIELD

The present disclosure relates to a diesel fuel filter for a vehicle.

### BACKGROUND

In general, diesel engines have advantages such as high thermal efficiency and low fuel costs, which are widely used for industrial fields, or in various fields such as ships and vehicles, and development of technology that improves fuel injection methods to improve output performance and reduce smoke is steadily being conducted.

The diesel engine contains a predetermined amount of moisture, and the amount of moisture generated by a change in external temperature is different. When the external temperature is high, as in summer, the generation amount of moisture is fine because the difference between the internal temperature and the external temperature of the engine is small. On the contrary, when the external temperature is low, such as in winter, the generation amount of moisture increases because the difference between the internal temperature and the external temperature of the engine is large. As such, a diesel fuel filter is applied to remove moisture (water) generated from diesel fuel.

A fuel filter (hereinafter, referred to as “diesel fuel filter”) applied to the diesel engine refers to a device that filters the diesel fuel supplied to the diesel engine, and the diesel fuel filter is installed between a fuel tank and a fuel pump, and performs a function of removing impurities such as moisture or foreign substances included in fuel.

Because the moisture or impurities filtered by the diesel fuel filter is stored in the diesel fuel filter, when moisture or impurities of a predetermined amount or more is stored, the moisture or impurities should be discharged to the outside. When the moisture or impurities stored in the diesel fuel filter is equal to or greater than a predetermined amount, an indication lamp is turned on a cluster of a vehicle to indicate, to a driver, an abnormality of the diesel fuel filter. Then, the driver may visit a repair shop to manually remove the moisture or foreign substances stored in the diesel fuel filter.

When the driver operates the vehicle for a long time without removing the moisture or impurities stored in the diesel fuel filter, the efficiency of the diesel filter can be lowered.

In addition, if the engine operates under extreme conditions, moisture is moved from the diesel fuel filter to a diesel injector, which may cause the diesel injector to corrode. When dust particles caused by the corrosion of the diesel injector are introduced into a combustion chamber of the engine, abnormal noise may occur in the engine or there may be a problem in starting the engine.

The above information disclosed in this Background section is provided only to enhance understanding of the background of the present disclosure and therefore it may contain information that does not form the prior art that is already known to a person of ordinary skill in the art.

### SUMMARY

The present disclosure is contrived to solve the problem, and has been made in an effort to provide a diesel fuel filter which may discharge water stored in a diesel fuel filter to the outside.

In an embodiment of the present disclosure, a diesel fuel filter includes: a filter module filtering and storing water contained in diesel fuel; and a sensor module that senses the amount of the water stored in the filter module and discharge the water to the outside. In particular, the sensor module may include: a sensor housing having at least one drain hole; a sensor body including a sensor tip measuring the amount of the water stored in the filter module. The sensor body further includes: a flap provided below the sensor tip and made of an elastic material, a sensor cover provided below the flap, and a sensor shaft provided inside the sensor cover and being selectively in communication with the flap. The sensor module includes: an elastic member providing elastic force in a direction in which the drain hole of the sensor housing is closed by the flap; and a driver selectively providing power so that the drain hole of the sensor housing is opened by the flap.

In some embodiments, a first flow path may be formed in the flap, and a second flow path which is selectively in communication with the first flow path may be formed in the sensor shaft.

In an embodiment, the flap may include an upper flap and a lower flap, and the first flow path may be formed between the upper flap and the lower flap.

In another embodiment, the first flow path may be opened or blocked by compression or stretching of the flap.

In one embodiment, one end of the flap may be connected to the sensor tip, and the other end of the flap may be connected to the sensor cover.

In an embodiment, when the amount of the water stored in the filter module is equal to or larger than a predetermined amount, the sensor body may move in an upper direction by operating the driver, such that the first flow path and the second flow path are configured to communicate with each other.

In an embodiment, the diesel fuel filter may further include an O-ring provided in the drain hole.

In an embodiment, the diesel fuel filter may further include a locking device configured to allow movement of the sensor body in upper and lower directions of the sensor body while preventing the movement of the sensor body in other directions.

In an embodiment, the locking device may include a locking protrusion formed in the sensor cover, and a protrusion groove formed on an inner peripheral surface of the drain hole. In particular, the protrusion groove is inserted with the locking protrusion and configured to limit the movement of the locking protrusion in the other directions other than the upper and lower directions.

In an embodiment, the protrusion groove may include a first vertical groove formed in the upper and lower directions, a circumferential groove formed in a circumferential direction of the drain hole from an end of the first vertical groove, and a second vertical groove formed in the upper and lower directions from an end of the circumferential groove.

Another embodiment of the present disclosure provides a vehicle which may include the diesel fuel filter.

According to an embodiment of the present disclosure, by the diesel fuel filter, the water stored in the diesel fuel filter is discharged to the outside, so the driver need not visit the repair shop in order to remove water stored in the diesel fuel filter.

Besides, an effect which can be obtained or predicted by the embodiments of the present disclosure is directly or implicitly disclosed in a detailed description of the present disclosure. Various effects predicted according to the present disclosure are disclosed in the detailed description to be described below.

### BRIEF DESCRIPTION OF THE DRAWINGS

These drawings are for the purpose of being referenced for describing an exemplary embodiment of the present disclosure, and therefore the technical spirit of the present disclosure should not be construed as being limited to the accompanying drawings.

FIG. 1 is a perspective view illustrating a configuration of a diesel fuel filter according to an embodiment of the present disclosure.

FIG. 2 is an exploded perspective view illustrating a configuration of a filter module of the diesel fuel filter according to an embodiment of the present disclosure.

FIG. 3 is an exploded perspective view illustrating a configuration of a sensor module of the diesel fuel filter according to an embodiment of the present disclosure.

FIG. 4 is a perspective view illustrating a configuration of a sensor body according to an embodiment of the present disclosure.

FIG. 5 is a perspective view illustrating a partial configuration of a sensor housing according to an embodiment of the present disclosure.

FIG. 6 is diagrams describing a process of coupling the sensor body to the sensor housing according to an embodiment of the present disclosure.

FIGS. 7A, 7B and 7C are diagrams describing an operation of the sensor module when a driver does not operate according to an embodiment of the present disclosure.

FIGS. 8A, 8B and 8C are diagrams describing an operation of the sensor module when a driving unit operates according to an embodiment of the present disclosure.

The drawings referenced above are not particularly illustrated according to a scale, but should be understood as presenting a somewhat brief expression of various features that illustrate the basic principles of the present disclosure. For example, the specific design features of the present disclosure, including specific dimensions, directions, positions, and shapes, should be partially determined by specific intended applications and use environments.

### DETAILED DESCRIPTION

The terms used here are only for describing specific embodiments, and are not intended to limit the present disclosure. As used here, the singular forms are also intended to include plural forms, unless they are explicitly differently indicated by context. It should be appreciated that when terms “include” and/or “including” are used in this specification, the terms “include” and/or “including” are intended to designate the existence of mentioned features, integers, steps, operations, constituent elements, and/or components, but do not exclude the existence or addition of one or more other features, integers, operations, constituent elements, and components, or groups thereof. As used here, the terms “and/or” include any one or all combinations of the items which are associated and listed.

The present disclosure is described in detail so as to be easily carried out by those having ordinary skill in the art to which the present disclosure pertains with reference to the accompanying drawings. However, the present disclosure can be realized in various different forms, and is not limited to the exemplary embodiments described herein.

A part irrelevant to the description has been omitted to clearly describe the present disclosure, and the same or similar elements are designated by the same reference numerals throughout the specification.

Further, since size and thickness of each component illustrated in the drawings are arbitrarily represented for convenience in explanation, the present disclosure is not particularly limited to the illustrated size and thickness of each component and the thickness is enlarged and illustrated in order to clearly express various parts and areas.

Suffixes “module” and/or “unit” for components used in the following description are given or mixed in consideration of easy preparation of the present disclosure only and do not have their own distinguished meanings or roles.

When a component, device, element, or the like of the present disclosure is described as having a purpose or performing an operation, function, or the like, the component, device, or element should be considered herein as being “configured to” meet that purpose or to perform that operation or function.

Further, in describing an embodiment disclosed in the present disclosure, a detailed description of related known technologies has been omitted if it is determined that the detailed description makes the gist of the embodiment of the present disclosure unclear.

Further, the accompanying drawings are provided for helping to easily understand some embodiments disclosed in the present specification, and the technical spirit disclosed in the present specification is not limited by the accompanying drawings, and it should be appreciated that the present disclosure includes all of the modifications, equivalent matters, and substitutes included in the spirit and the technical scope of the present disclosure.

Hereinafter, a diesel fuel filter according to the present disclosure is described in detail with reference to the accompanying drawings.

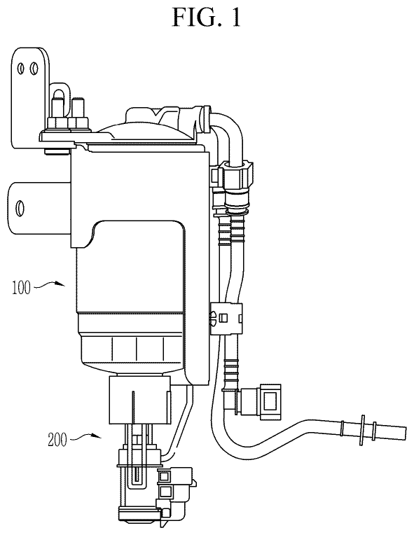

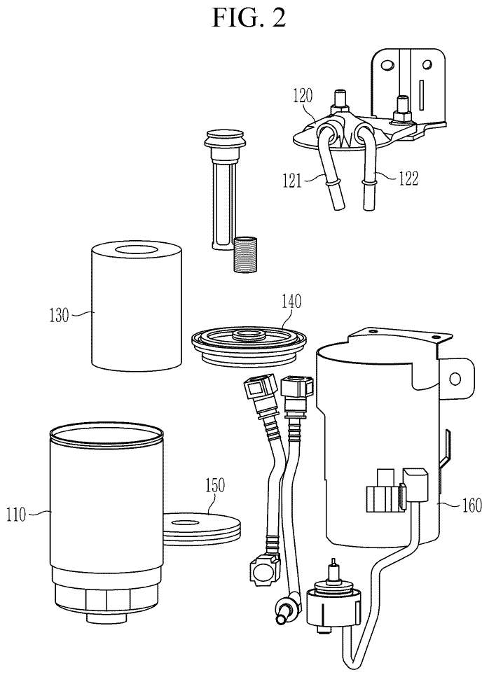

FIG. 1 is a perspective view illustrating a configuration of a diesel fuel filter according to the present disclosure. In addition, FIG. 2 is an exploded perspective view illustrating a configuration of a filter module 100 of the diesel fuel filter according to the present disclosure.

As illustrated in FIGS. 1 and 2, the diesel fuel filter according to the present disclosure which is applied to a diesel vehicle may include a filter module 100 filtering water and impurities contained in a diesel engine, and supplying the corresponding diesel fuel to an engine, and a sensor module 200 provided below a filter unit 130.

The filter module 100 may include a filter housing 110, a filter head 120 provided above the filter housing 110, the filter unit 130 provided inside the filter housing 110, an upper sealing 140 provided between the filter housing 110 and the filter head 120, a lower sealing 150 provided below the filter housing 110, and a filter bracket 160 provided to surround a circumference of the filter housing 110.

The filter housing 110 forms an external appearance of the filter module 100, and is formed in a substantially cylindrical shape. The filter housing 110 accommodates various components of the filter module 100 including the filter unit 130.

The filter head 120 forms the external appearance of the filter module 100 jointly with the filter housing 110, and covers an opened top of the filter housing 110. An inlet tube 121 and an outlet tube 122 are connected to the filter head 120. One side of the inlet tube 121 is connected to a fuel tank, and the other side is connected to the filter head 120. One side of the outlet tube 122 is connected to the filter head 120, and the other side is connected to a fuel pump. Diesel fuel is supplied from the fuel tank to the filter module 100 through the inlet tube 121, and the diesel fuel filtered by the filter unit 130 provided in the filter housing 110 is supplied to the fuel pump through the outlet tube 122. The water and impurities contained in the diesel fuel is filtered by the filter unit 130, and then stored in an internal space of the filter housing 110.

The upper sealing 140 and the lower sealing 150 prevent the diesel fuel which flows into the filter housing 110 from being leaked to the outside of the filter housing 110.

The filter housing 110 is fixed and installed into a vehicle body through the filter bracket 160.

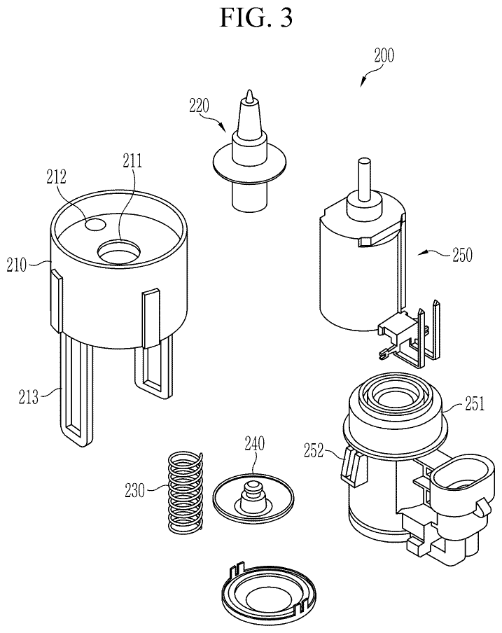

As illustrated in FIG. 3, the sensor module 200 may include a sensor housing 210, a sensor body 220 provided in the sensor housing 210, an elastic member 230 providing elastic force to the sensor body 220, and a driver 250 providing power to the sensor body 220.

The sensor housing 210 is formed in a substantially cylindrical shape, and has a first drain hole 211 and a second drain hole 212. The first drain hole 211 is formed at a center of the sensor housing 210, and the second drain hole 212 is formed to be eccentric to the second drain hole 212. The first drain hole 211 is formed to penetrate the sensor housing 210, and the sensor body 220 is movably inserted into the first drain hole 211. Substantially “U”-shaped couplers 213 are formed at both sides of the sensor housing 210. A driving housing 251 to be described below is coupled to the coupler 213.

The sensor body 220 measures the amount of water stored in the filter module 100, and discharges the water stored in the filter module 100 to the outside as necessary.

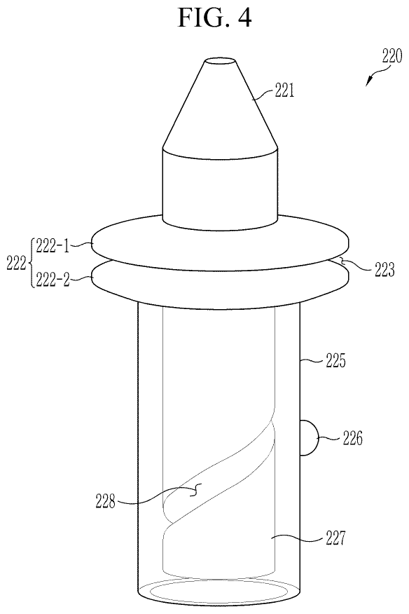

Referring to FIG. 4, the sensor body 220 may include a sensor tip 221 provided in the first drain hole 211 of the sensor housing 210, a flap 222 provided below the sensor tip 221, a sensor cover 225 provided below the flap 222, and a sensor shaft 227 provided in the sensor cover 225.

The sensor tip 221 measures the amount of water stored in the filter housing 110 of the filter module 100. The amount of the water in the filter housing 110 measured by the sensor tip 221 may be transmitted to a controller.

The flap 222 is made of an elastic material, and formed in the substantially cylindrical shape. The flap 222 may be made of, for example, a rubber material. A spiral first flow path 223 may be formed in the flap 222 in a circumferential direction. The flap 222 may be formed in a wrinkle pipe (or bellows) shape, and the first flow path 223 may be formed at the center of the flap 222 in the circumferential direction.

Since the flap 222 is made of the elastic material such as rubber, the first flow path 223 is blocked when the flap 222 is compressed in upper and lower directions. Contrary to this, when the flap 222 is stretched in the upper and lower directions, the first flow path 223 is opened.

One circumferential end of the flap 222 is connected to the sensor tip 221, and the other end is connected to the sensor cover 225. For example, the flap 222 may include an upper flap 222-1 and a lower flap 222-2, and the first flow path 223 may be selectively formed between the upper flap 222-1 and the lower flap 222-2. The upper flap 222-1 may be connected to the sensor tip 221, and the lower flap 222-2 may be connected to the sensor cover 225.

The lower flap 222-2 is fixed and connected to the sensor cover 225. In addition, the upper flap 222-1 may be fixed to the sensor tip 221 and compressed or stretched in link with a motion of the sensor shaft 227 of the sensor body 220. As a result, the first flow path 223 between the upper flap 222-1 and the lower flap 222-2 is opened or closed, so the first flow path 223 and the second flow path 228 may be selectively interlocked.

The sensor cover 225 is formed in the substantially cylindrical shape, and a space is formed between the sensor cover 225 and the sensor shaft 227. A locking protrusion 226 is formed on an outer peripheral surface of the sensor cover 225. The locking protrusion 226 may form a locking device jointly with a protrusion groove to be described below.

The sensor shaft 227 is fixedly connected to the sensor tip 221, and formed in a substantially columnar shape, and has a spiral second flow path 228 formed on the outer peripheral surface thereof in the circumferential direction. With the movement of the sensor shaft 227, the second flow path 228 is selectively in communication with the first flow path 223.

The elastic member 230 provides the elastic force to the sensor shaft 227. Specifically, the elastic member 230 may provide the elastic force in a direction in which the first drain hole 211 and the second drain hole 212 of the sensor housing 210 are closed by the flap 222. The elastic member 230 may provide the elastic force in a direction of pulling the sensor shaft 227 downwards. When the sensor shaft 227 is pulled downwards by the elastic force of the elastic member 230, the flap 222 covers an upper surface of the sensor housing 210, and as a result, the first drain hole 211 and the second drain hole 212 are closed by the flap 222.

Referring back to FIG. 3, a support plate 240 supporting the elastic member 230 is provided below the elastic member 230.

The driver 250 selectively provides the power to the sensor shaft 227. The driver 250 may be a solenoid. The driver 250 may selectively provide the elastic force to the sensor shaft 227 so that the first drain hole 211 and the second drain hole 212 of the sensor housing 210 are opened by the flap 222. The driver 250 may provide the power so as for the sensor shaft 227 to move upwards. When the sensor shaft 227 moves upwards by the driver 250, the sensor tip 221 also moves upwards, and an upper portion of the flap 222 connected to the sensor tip 221 is extended upwards. As a result, the first flow path 223 formed in the flap 222 is opened, and is in communication with the second flow path 228 formed in the sensor shaft 227.

The driver 250 is seated on the driving housing 251, and the driving housing 251 is coupled to the sensor housing 210. To this end, hook protrusions 252 are formed at both sides of the driving housing 251. The hook protrusion 252 of the driving housing 251 may be hook-coupled (or snap-fit coupled) to the coupler 213 of the sensor housing 210.

An O-ring 260 may be provided in the first drain hole 211. The water stored in the sensor housing 210 is prevented from being leaked between an inner surface of the first drain hole 211 of the sensor housing 210 and an outer surface of the sensor cover 225 by the O-ring 260.

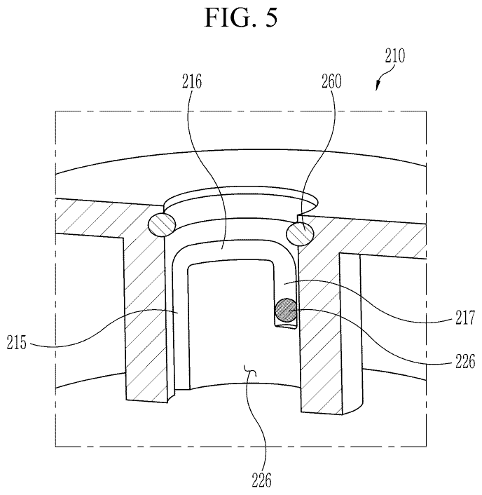

Meanwhile, referring to FIG. 5, the sensor module 200 of the diesel fuel filter according to the present disclosure may further include a locking device that limits the remaining movement other than upper and lower-direction movement of the sensor body 220. In other words, after the sensor body 220 is coupled to the sensor housing 210, the locking device enables the sensor body 220 to move only in upper and lower directions, and movement of the sensor body 220 in the other directions other than the upper and lower directions is limited or prevented.

To this end, the locking device may include a locking protrusion 226 formed on an outer peripheral surface of the sensor cover 225 of the sensor body 220, and a protrusion groove formed on an inner peripheral surface of the first drain hole 211 of the sensor housing 210. The locking protrusion 226 is inserted into the protrusion groove, thereby configuring the locking device to limit the movement of the sensor body 220 to the upper and lower directions. This is because the locking protrusion 226 is allowed to move solely in the upper and lower directions.

The protrusion groove may include a first vertical groove 215 on the inner peripheral surface of the first drain hole 211 of the sensor housing 210 in the upper and lower directions, a circumferential groove 216 formed in the circumferential direction of the first drain hole 211 from an end of the first vertical groove 215, and a second vertical groove 217 formed in the upper and lower directions from an end of the circumferential groove 216.

A process of coupling the sensor body 220 to the sensor housing 210 is described below.

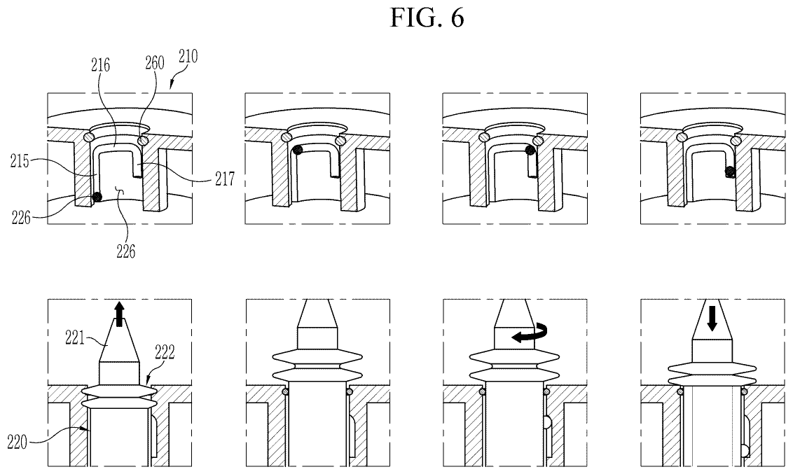

Referring to FIG. 6, the locking protrusion 226 of the sensor body 220 is inserted into the first vertical groove 215, and then moves the sensor body 220 up to an upper end of the first vertical groove 215. In addition, when the sensor body 220 is rotated in the circumferential direction, the locking protrusion 226 of the sensor body 220 moves along the circumferential groove 216. Thereafter, when the sensor body 220 is moved downwards, the locking protrusion 226 of the sensor body 220 moves downward along the second vertical groove 217.

As such, in a state in which the locking protrusion 226 of the sensor body 220 is inserted into the second vertical groove 217, the elastic force of the elastic member 230 is applied to the sensor body 220 in the upper and lower directions, and the power by the driver 250 is also applied to the sensor body 220 only in the upper and lower directions, so the sensor body 220 may move only in the upper and lower directions. In other words, the movement of the sensor body 220 in the remaining directions other than the upper and lower directions is limited.

The diesel fuel filter according to the present disclosure may further include a controller that controls the driver 250 according to the amount of water measured by the sensor tip 221 of the sensor module 200. The controller may operate the driver 250 when the amount of water in the filter housing 110 is a set amount or more.

To this end, the controller may be implemented as one or more processors which operate by a set program, and a memory of the controller stores program instructions programmed to perform each step of a control method of the diesel fuel filter according to the present disclosure through one or more processors.

Hereinafter, the operation of the diesel fuel filter according to the present disclosure is described in detail.

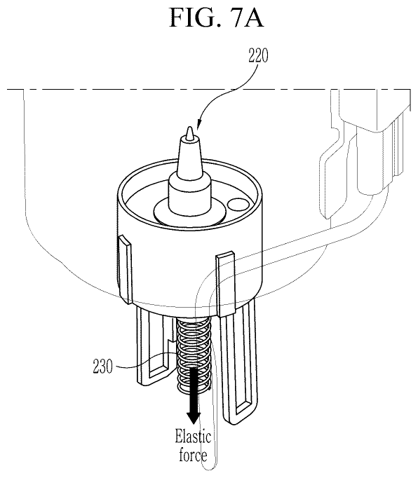

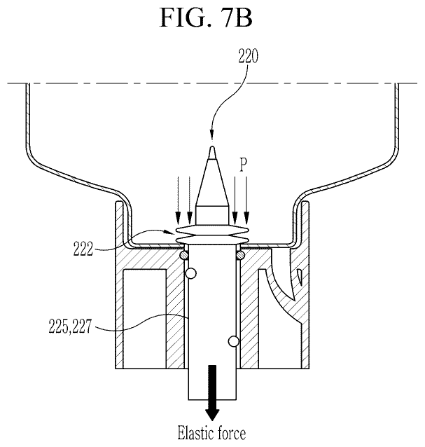

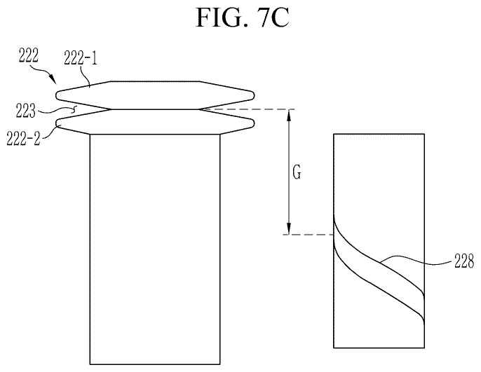

Referring to FIGS. 7A and 7B, when a small amount of water is stored in the filter housing 110, the amount of water measured by the sensor tip 221 of the sensor module 200 is sensed to be less than a set amount, and the sensed amount of water is transmitted to the controller. In this case, the controller does not control the driver 250.

When the driver 250 does not operate, the flap 222 is compressed by the elastic force of the elastic member 230 which pulls the sensor shaft 227 of the sensor module 200 downwards, and as a result, the first flow path 223 formed in the flap 222 is closed. At the same time, the flap 222 is compressed by the water stored in the filter housing 110 and a pressure P of the diesel fuel. The first flow path 223 is closed due to the compression of the flap 222, and the first drain hole 211 is also closed. Accordingly, the water stored in the filter housing 110 is not discharged to the first drain hole 211 through the first flow path 223.

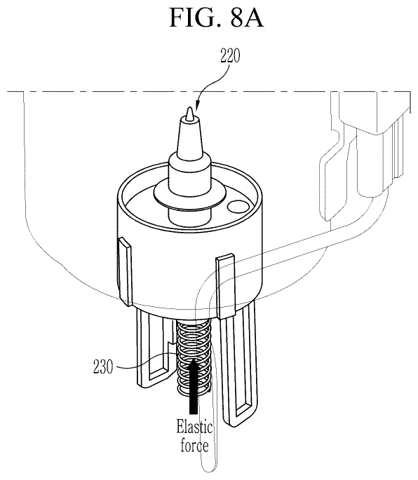

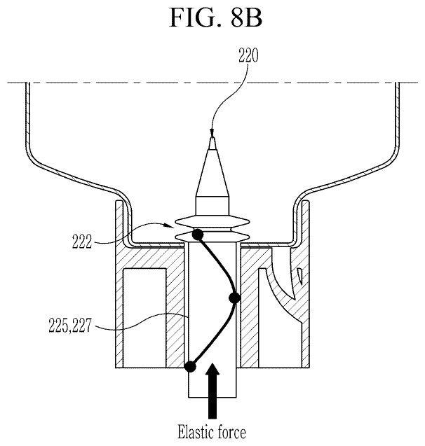

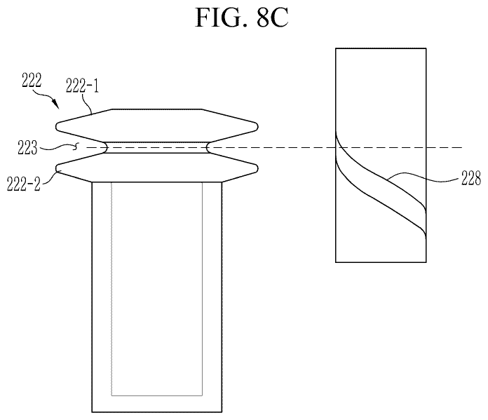

Referring to FIGS. 8A and 8B, when water of a set amount or more is stored in the filter housing 110, the amount of water measured by the sensor tip 221 of the sensor module 200 is sensed to be equal to or more than the predetermined amount, and the sensed amount of water is transmitted to the controller. In this case, the controller operates the driver 250.

When the driver 250 is operated, the sensor shaft 227 is pushed up in the upper direction while overcoming the elastic force of the elastic member 230 by the driver 250. As a result, while the flap 222 is stretched in the upper and lower directions, the first flow path 223 of the flap 222 is opened. Further, the sensor shaft 227 is moved in the upper direction by the driver 250, and as a result, the first flow path 223 of the flap 222 and the second flow path 228 of the sensor shaft 227 are in communication with each other. Accordingly, the water stored in the filter housing 110 is discharged to the outside of the sensor module 200 through the first flow path 223 and the second flow path 228.

The controller operates the driver 250 only for a set time, and when the set time elapses, stops the operation of the driver 250. When the operation of the driver 250 is stopped, the first flow path 223 of the flap 222 is closed while the sensor shaft 227 moves in the upper direction by the elastic force of the elastic member as described above.

By the diesel fuel filter according to the present disclosure described above, when the amount of the water stored in the filter housing 110 of the filter module 100 is equal to or more than the predetermined amount, the first flow path 223 formed in the flap 222 of the sensor module 200 and the second flow path 228 formed in the sensor shaft 227 are in communication with each other, and the water is discharged to the outside of the sensor module 200 through the first flow path 223 and the second flow path 228. As a result, when the water of the set amount or more is stored in the diesel fuel filter, an inconvenient task performed by a user, such as a driver, need not separately visit the repair shop, may be removed.

Although some embodiments of the present disclosure are described hereinabove, the present disclosure is not limited thereto. Various modifications can be made within the scope of the claims, and the detailed description of the present disclosure and the accompanying drawings, and they belong to the scope of the present disclosure, of course.

### DESCRIPTION OF SYMBOLS

100: Filter module
110: Filter housing
120: Filter head
121: Inlet tube
122: Outlet tube
130: Filter unit
140: Upper sealing
150: Lower sealing
160: Filter bracket
200: Sensor module
210: Sensor housing
211: Drain hole
213: Coupler
215: First vertical groove
216: Circumferential groove
217: Second vertical groove
220: Sensor body
221: Sensor tip
222: Flap
223: First flow path
225: Sensor cover
226: Locking protrusion
227: Sensor shaft
228: Second flow path
230: Elastic member
240: Support plate
250: Driver
251: Driving housing
252: Hook protrusion
260: O-ring

What is claimed is:

1. A diesel fuel filter comprising:
a filter module filtering and storing water contained in diesel fuel; and
a sensor module configured to sense an amount of the water stored in the filter module and discharge the water to the outside,
wherein the sensor module includes:
a sensor housing including at least one drain hole;
a sensor body including a sensor tip measuring the amount of the water stored in the filter module, a flap provided below the sensor tip and made of an elastic material, a sensor cover provided below the flap, and a sensor shaft provided inside the sensor cover and configured to selectively communicate with the flap;
an elastic member providing elastic force in a direction in which the at least one drain hole of the sensor housing is closed by the flap; and
a driver selectively providing power so that the at least one drain hole of the sensor housing is opened by the flap.

2. The diesel fuel filter of claim 1, wherein a first flow path is formed in the flap, and a second flow path is formed in the sensor shaft, wherein the second flow path is selectively in communication with the first flow path.

3. The diesel fuel filter of claim 2, wherein the flap includes an upper flap and a lower flap, and the first flow path is formed between the upper flap and the lower flap.

4. The diesel fuel filter of claim 3, wherein the first flow path is opened or blocked by compression or stretching of the flap.

5. The diesel fuel filter of claim 3, wherein one end of the flap is connected to the sensor tip, and another end of the flap is connected to the sensor cover.

6. The diesel fuel filter of claim 2, wherein when the amount of the water stored in the filter module is equal to or greater than a predetermined amount, the sensor body moves in an upper direction by operating the driver, such that the first flow path and the second flow path are configured to communicate with each other.

7. The diesel fuel filter of claim 1, further comprising:
an O-ring provided in the drain hole.

8. The diesel fuel filter of claim 1, further comprising:
a locking device configured to allow a movement of the sensor body in upper and lower directions of the sensor body while preventing the movement in other directions.

9. The diesel fuel filter of claim 8, wherein the locking device includes:
a locking protrusion formed in the sensor cover, and
a protrusion groove formed on an inner peripheral surface of the drain hole, wherein the protrusion groove is inserted with the locking protrusion and configured to limit a movement of the locking protrusion in the other directions other than the upper and lower directions.

10. The diesel fuel filter of claim 9, wherein the protrusion groove includes:
a first vertical groove formed in the upper and lower directions,
a circumferential groove formed in a circumferential direction of the drain hole from an end of the first vertical groove, and
a second vertical groove formed in the upper and lower directions from an end of the circumferential groove.

11. A vehicle including the diesel fuel filter of claim 1.
